(19) United States
(12) Patent Application Publication
(10) Pub. No.: US 2017/0346537 A1
(43) Pub. Date: Nov. 30, 2017

(54) WIRELESS COMMUNICATION DEVICE AND CALIBRATION METHOD

(71) Applicant: FUJITSU LIMITED, Kawasaki-shi (JP)

(72) Inventors: TOMONORI SATO, Kawasaki (JP); DAISUKE OGAWA, Yokosuka (JP); Kazuo Nagatani, Yokohama (JP)

(73) Assignee: FUJITSU LIMITED, Kawasaki-shi (JP)

(21) Appl. No.: 15/499,844

(22) Filed: Apr. 27, 2017

(30) Foreign Application Priority Data
May 25, 2016 (JP) 2016-104441

(51) Int. Cl. H04B 7/06; H04B 1/40; H04B 7/08; H04B 7/0452; H04B 17/13; H04B 17/12

(52) U.S. Cl. CPC H04B 7/061; H04B 7/0686; H04B 1/40; H04B 7/0885; H04B 17/13; H04B 17/12; H04B 7/0452

(57) ABSTRACT

A wireless communication device includes a plurality of antennas, transmission circuits, reception circuits, and a plurality of connecting units that connect the transmission circuits and the reception circuits associated with the respective antennas, and a processor. The processor executes outputting, at timing allowed for signal transmission from the antennas, first calibration signals; calculating, by using the first calibration signals having passed through the transmission circuits, a first correction value that corrects a difference between the transmission characteristics of the transmission circuits; outputting, at the timing allowed for the signal transmission from the antennas, a second calibration signal; and calculating, by using the second calibration signal having passed through the reception circuits, a second correction value that corrects a difference between the transmission characteristics of the reception circuits.

### CROSS-REFERENCE TO RELATED APPLICATION

This application is based upon and claims the benefit of priority of the prior Japanese Patent Application No. 2016-104441, filed on May 25, 2016, the entire contents of which are incorporated herein by reference.

### FIELD

The embodiments discussed herein are related to a wireless communication device and a calibration method.

### BACKGROUND

In the fifth generation (5G) mobile communication system in which research has started in recent years, a further increase in the network capacity is expected. As the technology that supports an increase in the network capacity, for example, an adaptive array antennas, massive multi input multi output (MIMO), or the like, are present. In the adaptive array antennas or massive MIMO, a plurality of antennas provided with the wireless communication device is used; however, it is preferable that the transmission characteristics of the antennas be the same. The transmission characteristics of the antennas mentioned here indicate the transmission characteristics of the signals at the circuits that are connected to the antennas.

As described above, the transmission characteristics between the plurality of the antennas are preferably the same; however, in general, the transmission characteristics of the respective antennas are different with each other due to, for example, an individual difference between electrical power amplifiers connected for the respective antennas, the variation in the temperature of the placement location of the antennas. Due to the difference between the transmission characteristics of the antennas, at the time of beamforming, the direction of a beam is shifted from an ideal direction or side lobes are increased. Consequently, an interference wave is not sufficiently suppressed, which may possibly cause the degradation of the communication characteristics. Thus, calibration that corrects the difference between the transmission characteristics of each of the antennas is sometimes performed.

Specifically, a correction value that corrects the difference between the transmission characteristics of each of the antennas is calculated and the calculated correction value is multiplied by both the transmission signal and the reception signal, whereby the difference between the transmission characteristics of the antennas is corrected. For example, in calibration at the time of transmission, different calibration signals are input to the respective transmission circuits associated with the respective antennas and, on the basis of the calibration signals passing through the transmission circuits, the transmission characteristic for each of the antennas is obtained. Then, from the transmission characteristic of the reference antenna and the transmission characteristics of the other antennas, a correction value for each of the antennas is calculated. As the correction value, for example, the ratio of the transmission characteristic of each of the antennas to the transmission characteristic of the reference antenna is obtained. Consequently, because the correction value calculated for each of the antennas is multiplied by the transmission signal that is output from each of the antenna, the transmission characteristic of each of the antennas can be made to match with the transmission characteristic of the reference antenna.

Furthermore, in calibration at the time of reception, the same calibration signal is input to the reception circuits that are associated with the respective antennas and, on the basis of the calibration signals that have passed through the reception circuits, a transmission characteristic for each of the antennas is obtained. Subsequently, similarly to the process performed at the time of transmission, a correction value for each of the antennas is calculated from the transmission characteristic for each of the antennas. At this point, at the time of reception, because a calibration signal is added to the reception signal at each of the antennas, when demodulation of the reception signal is performed, the calibration signal added to the reception signal is previously removed. Consequently, an amount of processing at the time when the reception signal is demodulated is increased. Furthermore, a part of the calibration signal that is input to the reception circuit is emitted from the antennas and a radio wave may sometimes be emitted from the antennas in spite of reception timing.

Thus, studies have been conducted on a technology that provides a plurality of radio frequency (RF) switches each of which connects transmission circuits and the reception circuits associated with the respective antennas that obtains, by switching the RF switches at the transmission timing, the transmission characteristics of both the transmission circuits and the reception circuits.

Patent Document 1: Japanese Laid-open Patent Publication No. 2000-216618

Patent Document 2: Japanese Laid-open Patent Publication No. 2009-278529

Patent Document 3: International Publication Pamphlet No. WO 2009/060598

However, when calibration is performed by switching the RF switches at the transmission timing, because the RF switches are arranged in the transmission circuits and the reception circuits associated with the respective antennas, the size of the circuits is increased. Furthermore, because calibration is performed while each of the RF switches is being switched, there is a problem in that the period of time until calibration for all of the antennas has been completed becomes long.

### SUMMARY

According to an aspect of an embodiment, a wireless communication device includes: a plurality of antennas; a plurality of transmission circuits that perform a transmission process on signals transmitted from the plurality of the respective antennas; a plurality of reception circuits that perform a reception process on signals received by the plurality of the respective antennas; a plurality of connecting units that connect the transmission circuits and the reception circuits associated with the plurality of the respective antennas, that output, to the respective antennas, the signals input from transmission circuit side, and that output, to the respective reception circuits, the signals input from antenna side; and a processor that is connected to the plurality of the transmission circuits and the plurality of the reception circuits. The processor executes a process including: outputting, at a timing allowed for signal transmission from the plurality of the antennas, first calibration signals that are different for the plurality of the transmission circuits; calculating, by using the first calibration signals having passed through the plurality of the transmission circuits and the respective connecting units, a first correction value that corrects a difference between the transmission characteristics of the plurality of the transmission circuits; outputting, at the timing allowed for the signal transmission from the plurality of the antennas, a second calibration signal that is common to the plurality of the reception circuits; and calculating, by using the second calibration signal having passed through the plurality of the connecting units and the respective reception circuits, a second correction value that corrects a difference between the transmission characteristics of the plurality of the reception circuits.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the configuration of a wireless communication device according to a first embodiment;

FIG. 2 is a flowchart illustrating transmission calibration according to the first embodiment;

FIG. 3 is a schematic diagram illustrating a specific example of the signal configuration at the time of transmission calibration;

FIG. 4 is a flowchart illustrating reception calibration according to the first embodiment;

FIG. 5 is a schematic diagram illustrating a specific example of the signal configuration at the time of reception calibration;

FIG. 6 is a schematic diagram illustrating a specific example of a calibration timing;

FIG. 7 is a schematic diagram illustrating a specific example of a calibration timing;

FIG. 8 is a block diagram illustrating a modification of the wireless communication device according to the first embodiment;

FIG. 9 is a block diagram illustrating the configuration of a wireless communication device according to a second embodiment;

FIG. 10 is a flowchart illustrating transmission calibration according to the second embodiment;

FIG. 11 is a flowchart illustrating reception calibration according to the second embodiment;

FIG. 12 is a block diagram illustrating the configuration of a wireless communication device according to a third embodiment;

FIG. 13 is a flowchart illustrating reception calibration according to the third embodiment; and

FIG. 14 is a block diagram illustrating the configuration of a wireless communication device according to a fourth embodiment.

### DESCRIPTION OF EMBODIMENTS

Preferred embodiments of the present invention will be explained with reference to accompanying drawings. The present invention is not limited to the embodiments.

### [a] First Embodiment

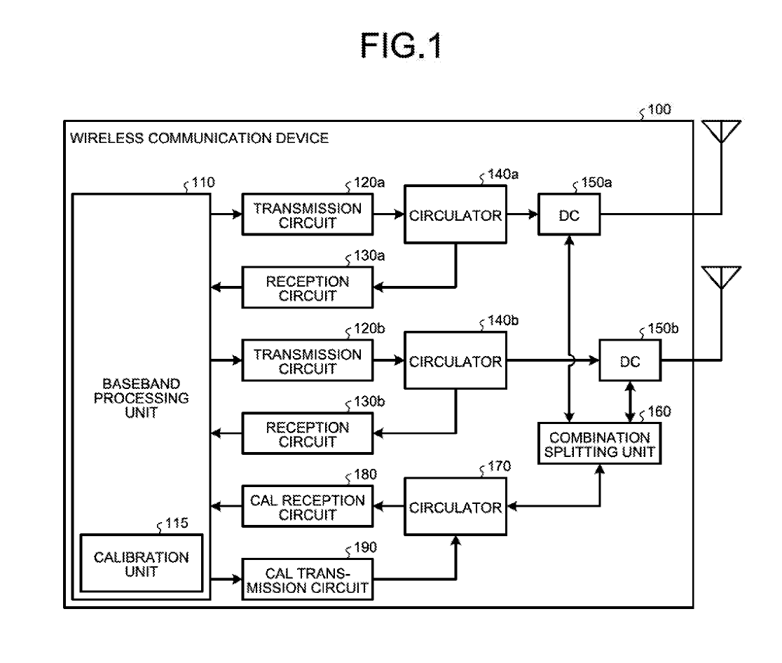

FIG. 1 is a block diagram illustrating the configuration of a wireless communication device 100 according to the first embodiment. The wireless communication device 100 illustrated in FIG. 1 includes a baseband processing unit 110, transmission circuits 120a and 120b, reception circuits 130a and 130b, circulators 140a and 140b, and directional couplers (DCs) 150a and 150b. The transmission circuit 120a, the reception circuit 130a, the circulator 140a, and the DC 150a are associated with one of antennas, whereas the transmission circuit 120b, the reception circuit 130b, the circulator 140b, and the DC 150b are associated with the other one of the antennas. In FIG. 1, the wireless communication device 100 having two antennas is illustrated; however, the wireless communication device 100 may also have three or more antennas and, accordingly, the transmission circuits, the reception circuits, the circulators, and the DCs are provided by being associated with the respective antennas. Furthermore, the wireless communication device 100 includes a combination splitting unit 160, a circulator 170, a calibration (CAL) reception circuit 180, and a CAL transmission circuit 190.

The baseband processing unit 110 is constituted by using a processor, for example, a field programmable gate array (FPGA), an application specific integrated circuit (ASIC), a digital signal processor (DSP), a central processing unit (CPU), or the like, and performs baseband process on a signal. Namely, the baseband processing unit 110 encodes and modulates transmission data, generates a transmission signal, and outputs the generated transmission signal to the transmission circuits 120a and 120b. Furthermore, the baseband processing unit 110 obtains reception data by demodulating and decoding the reception signal that is output from each of the reception circuits 130a and 130b. Furthermore, the baseband processing unit 110 performs transmission calibration that corrects the transmission characteristics of the transmission circuits 120a and 120b for the respective antennas and performs reception calibration that corrects the transmission characteristics of the reception circuits 130a and 130b for the respective antennas.

Specifically, the baseband processing unit 110 includes a calibration unit 115. The calibration unit 115 performs transmission calibration and reception calibration at the defined transmission timing that is defined in a wireless communication system that uses time division duplex (TDD). Namely, in the wireless communication system that uses TDD, because uplink and downlink communication is performed in a time division manner, the timing allowed for signal transmission from the antennas in the wireless communication device 100 is defined. Thus, the calibration unit 115 performs calibration on the transmission circuits 120a and 120b and the reception circuits 130a and 130b at the transmission timing allowed for the signal transmission from the wireless communication device 100.

When transmission calibration is performed, the calibration unit 115 adds different calibration signals to the transmission signals output to the transmission circuits 120a and 120b associated with the respective antennas. Then, the calibration unit 115 extracts the calibration signals added to the signal that is output from the CAL reception circuit 180 and estimates the transmission characteristics of the transmission circuits 120a and 120b on the basis of the calibration signals. Thereafter, the calibration unit 115 uses the ratios of the estimated transmission characteristics as correction values, multiplies each of the correction values by the transmission signals that are output to the transmission circuits 120a and 120b, and corrects the transmission signals. Consequently, the transmission characteristics of the transmission circuits 120a and 120b are made to match.

In contrast, when reception calibration is performed, the calibration unit 115 outputs a calibration signal to the CAL transmission circuit 190. Then, the calibration unit 115 extracts the calibration signals output from the respective reception circuits 130a and 130b and estimates the transmission characteristics of the reception circuits 130a and 130b on the basis of the calibration signals. Then, the calibration unit 115 uses the ratios of the estimated transmission characteristics as correction values, multiplies each of the correction values by the reception signals that are output from the reception circuits 130a and 130b, and corrects the reception signals. Consequently, the transmission characteristics of the reception circuits 130a and 130b are made to match.

The transmission circuits 120a and 120b perform digital-to-analog (DA) conversion and up-conversion on the respective transmission signals and output the obtained transmission signals having the radio frequency to the circulators 140a and 140b, respectively.

The reception circuits 130a and 130b perform down-conversion and analog-to-digital (AD) conversion on the respective reception signals having the radio frequency output from the respective circulators 140a and 140b, respectively, and output the obtained baseband reception signals to the baseband processing unit 110.

Each of the circulators 140a and 140b has at least three ports and outputs the signal that is input from one of the ports to the subsequent port. Namely, the circulators 140a and 140b output, to the port connected to the respective antennas, the signals that are input from the ports connected to the transmission circuits 120a and 120b, respectively, and output the signals that are input from the ports connected to the respective antennas to the reception circuits 130a and 130b, respectively.

Specifically, in the transmission timing defined in TDD, the circulators 140a and 140b output the transmission signals that are output from the transmission circuits 120a and 120b to the DCs 150a and 150b, respectively. Furthermore, in the transmission timing defined in TDD, the circulators 140a and 140b output the calibration signals, which are input from the antenna side, to the reception circuits 130a and 130b, respectively. Furthermore, in the reception timing defined in TDD, the circulators 140a and 140b output the reception signals received via the respective antennas to the reception circuits 130a and 130b, respectively.

The DCs 150a and 150b transmits, via the antennas, the transmission signals output from the circulators 140a and 140b, respectively, and then output the transmission signals to the combination splitting unit 160. Accordingly, in the transmission timing defined in the TDD, the DCs 150a and 150b output, to the combination splitting unit 160, the transmission signals to each of which a calibration signal is added. Furthermore, the DCs 150a and 150b output, to the circulators 140a and 140b, respectively, the calibration signals output from the combination splitting unit 160. Namely, in the transmission timing defined in TDD, the DCs 150a and 150b output the calibration signals that are used for reception calibration to the circulators 140a and 140b, respectively.

The combination splitting unit 160 combines the transmission signals output from the DCs 150a and 150b, respectively, and outputs the output signals to the circulator 170. Namely, the combination splitting unit 160 combines the transmission signals that have passed through the transmission circuits 120a and 120b and outputs the transmission signals to the circulator 170. In the transmission timing defined in TDD, different calibration signals are attached to these transmission signals. Furthermore, the combination splitting unit 160 splits the calibration signals output from the circulator 170 into the DCs 150a and 150b. Namely, the combination splitting unit 160 splits the calibration signals used for reception calibration into the DCs 150a and 150b.

The circulator 170 outputs the signal from the combination splitting unit 160 to the CAL reception circuit 180. Namely, in the transmission timing defined in TDD, the circulator 170 outputs, to the CAL reception circuit 180, the combined signal that is obtained by combining the transmission signals to each of which the calibration signal is added. Furthermore, the circulator 170 outputs, to the combination splitting unit 160, the calibration signal output from the CAL transmission circuit 190. Namely, in the transmission timing defined in TDD, the circulator 170 outputs, to the combination splitting unit 160, the calibration signal used for reception calibration.

The CAL reception circuit 180 performs down-conversion and AD conversion on the combined signal output from the circulator 170 and then outputs the obtained baseband combined signal to the calibration unit 115.

The CAL transmission circuit 190 performs DA conversion and up-conversion the calibration signals that are used for reception calibration and that are output from the calibration unit 115 and then outputs the obtained calibration signal having the radio frequency to the circulator 170.

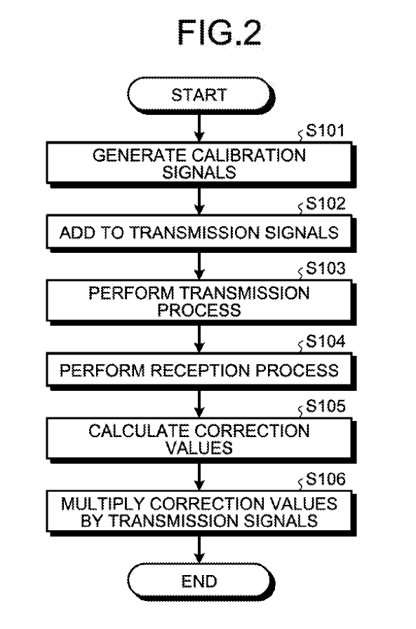

In the following, transmission calibration performed in the wireless communication device 100 configured described above will be described with reference to the flowchart illustrated in FIG. 2. The transmission calibration described below is performed in the transmission timing defined in TDD.

At the time of transmission calibration, the calibration signals that are different for the respective transmission circuits 120a and 120b are generated by the calibration unit 115 (Step S101). The generated calibration signals are added to the respective transmission signals (Step S102) and are output to the respective transmission circuits 120a and 120b.

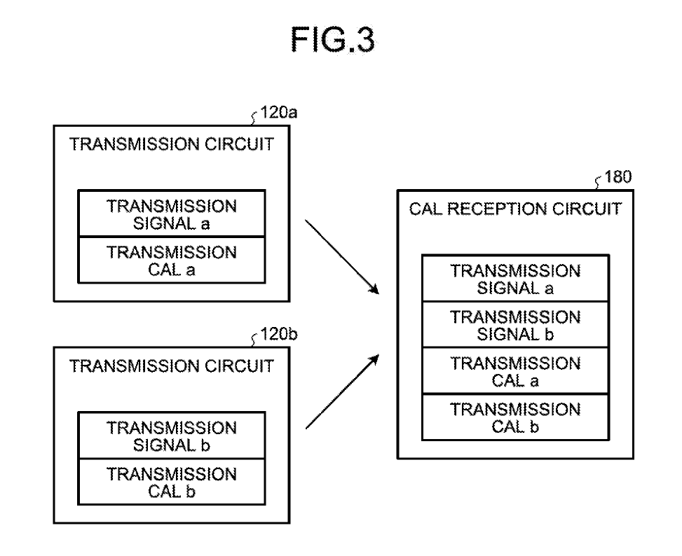

Then, the transmission process is performed by the transmission circuits 120a and 120b on the transmission signals to each of which the calibration signals are added (Step S103). Specifically, the transmission signals are subjected to the DA conversion and up-conversion by the respective transmission circuits 120a and 120b and then the transmission signals having the radio frequency are output to the respective circulators 140a and 140b. At this time, as indicated on the left side of FIG. 3, a transmission CAL a that is a calibration signal is added to a transmission signal a that is subjected to the transmission process by the transmission circuit 120a, whereas a transmission CAL b that is a calibration signal and that is different from the transmission CAL a is added to a transmission signal b that is subjected to the transmission process by the transmission circuit 120b. Namely, the calibration signals used for transmission calibration are different for each of the transmission circuits.

The transmission signals that have been subjected to the transmission process are transmitted via the antennas by way of the circulators 140a and 140b and the DCs 150a and 150b, respectively. Furthermore, in the DCs 150a and 150b, the transmission signals to each of which the calibration signal is added are also output to the combination splitting unit 160. The transmission signals output from the DCs 150a and 150b are combined by the combination splitting unit 160 and the obtained combined signal is input to the CAL reception circuit 180 by way of the circulator 170.

Then, a reception process with respect to the combined signal is performed by the CAL reception circuit 180 (Step S104). Specifically, the combined signal is subjected to down-conversion and AD conversion by the CAL reception circuit 180 and then the combined signal having the baseband frequency is output to the calibration unit 115. At this time, as indicated on the right side of FIG. 3, in the combined signal that is subjected to the reception process by the CAL reception circuit 180, the transmission signal a and the transmission signal b that have been subjected to the transmission process by the transmission circuits 120a and 120b, respectively, and a transmission CAL a and a transmission CAL b that are calibration signals and that are added to the respective transmission signals are included.

If the combined signal that includes therein the calibration signals is input to the calibration unit 115, the calibration signals for the respective transmission circuits are extracted by the calibration unit 115. Namely, the transmission CAL a and the transmission CAL b illustrated in FIG. 3 are extracted. Then, the transmission characteristics of the transmission circuits 120a and 120b are estimated by comparing the phase and the amplitude of the extracted calibration signals with the phase and the amplitude of the calibration signal that is generated at first. Here, on the basis of the transmission CAL a, the transmission characteristic of the transmission circuit 120a is estimated, and, on the basis of the transmission CAL b, the transmission characteristic of the transmission circuit 120b is estimated.

Then, a correction value that is used to match the transmission characteristics of the transmission circuits is calculated from the transmission characteristics of the respective transmission circuits (Step S105). Specifically, for example, if the transmission characteristic of the transmission circuit 120a is set to T₁ and the transmission characteristic of the transmission circuit 120b is set to T₂, a correction value Cb that corrects the transmission characteristic of the transmission circuit 120b is calculated as Cb=T₁/T₂. At this time, a correction value Ca that corrects the transmission characteristic of the transmission circuit 120a is Ca=T₁/T₁=1.

After the correction values for each of the transmission circuits have been calculated by the calibration unit 115, the correction value is multiplied by the transmission signal that is output to each of the transmission circuits (Step S106). Accordingly, for example, the correction value Ca described above is multiplied by the transmission signal that is output to the transmission circuit 120a and the correction value Cb described above is multiplied by the transmission signal that is output to the transmission circuit 120b. Consequently, it is possible to assume that all of the transmission signals that are to be subjected to the transmission process by the respective transmission circuits 120a and 120b are transmitted to the antennas having the same transmission characteristic as that of the transmission circuit 120a and thus it is possible to match the transmission characteristics of the transmission circuits associated with the respective antennas.

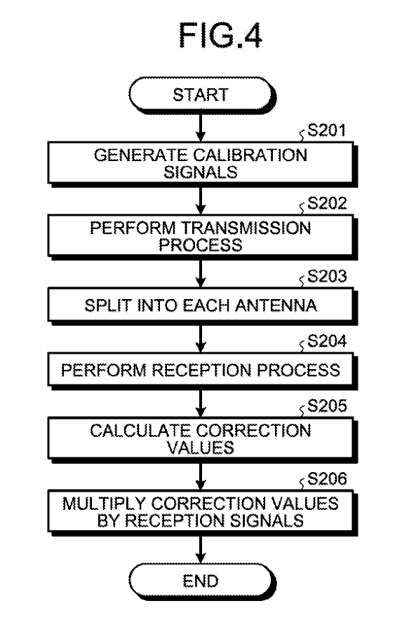

In the following, reception calibration performed in the wireless communication device 100 according to the first embodiment will be described with reference to the flowchart illustrated in FIG. 4. The reception calibration described below is performed in the transmission timing defined in TDD.

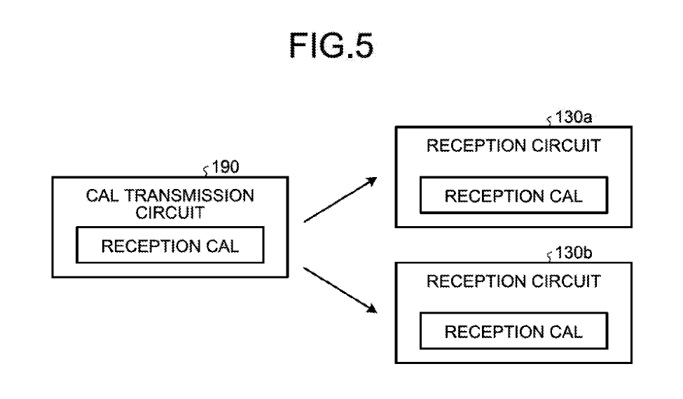

At the time of reception calibration, a calibration signal that is common to the reception circuits 130a and 130b is generated by the calibration unit 115 (Step S201). The generated calibration signal is input to the CAL transmission circuit 190 and the transmission process with respect to the calibration signal is performed by the CAL transmission circuit 190 (Step S202). Specifically, the calibration signal is subjected to DA conversion and up-conversion by the CAL transmission circuit 190 and the calibration signal having the radio frequency is output to the circulator 170. At this time, as indicated on the left side of FIG. 5, the number of calibration signals subjected to the transmission process by the CAL transmission circuit 190 is one and the calibration signal that is commonly used by the plurality of the reception circuits 130a and 130b is subjected to the transmission process.

The calibration signal that has been subjected to the transmission process is output from the circulator 170 to the combination splitting unit 160 and is split, by the combination splitting unit 160, into the DCs 150a and 150b that are associated with the respective antennas (Step S203). The calibration signal split into the DCs 150a and 150b is input to the reception circuits 130a and 130b by way of the circulators 140a and 140b, respectively. Furthermore, the calibration signal that is split into the DCs 150a and 150b is also emitted from some antenna; however, because reception calibration is performed in the transmission timing, the influence is small even if a radio wave is emitted.

If the calibration signal is input to the reception circuits 130a and 130b, the reception process with respect to the calibration signal is performed (Step S204). Specifically, the calibration signals are subjected to down-conversion and AD conversion by the reception circuits 130a and 130b and the calibration signals having the baseband frequency are output to the calibration unit 115. At this time, as indicated on the right side of FIG. 5, the calibration signals that have been subjected to the reception process by the reception circuits 130a and 130b are the same signals.

If the calibration signals associated with the respective reception circuits are input to the calibration unit 115, the phase and the amplitude of the calibration signals associated with the respective reception circuits are compared with the phase and the amplitude of the calibration signals that are generated at first, whereby the transmission characteristics of the reception circuits 130a and 130b are estimated. Then, the correction values that are used to match the transmission characteristics of the reception circuits are calculated from the transmission characteristics of the respective reception circuits (Step S205). Specifically, for example, if the transmission characteristic of the reception circuit 130a is set to R₁ and the transmission characteristic of the reception circuit 130b is set to R₂, the correction value C*b that corrects the transmission characteristic of the reception circuit 130b is calculated as C*b=R₁/R₂. At this point, the correction value C*a that corrects the transmission characteristic of the reception circuit 130a is C*a=R₁/R₁=1.

After the correction value for each reception circuit has been calculated by the calibration unit 115, the correction value is multiplied by the reception signal that is output from each of the reception circuits (Step S206). Accordingly, for example, the correction value C a described above is multiplied by the reception signal that is output from the reception circuit 130a, whereas the correction value C*b described above is multiplied by the reception signal that is output from the reception circuit 130b. Consequently, it is possible to assume that all of the reception signals that are to be subjected to the reception process by the respective reception circuits 130a and 130b are transmitted from the antennas having the same transmission characteristic as that of the reception circuit 130a and thus it is possible to match the transmission characteristics of the reception circuits associated with the respective antennas.

The transmission calibration and the reception calibration described above are performed in the transmission timing defined in TDD. Namely, in the wireless communication system that uses TDD, because uplink and downlink communication is performed in a time division manner, if the wireless communication device 100 is, for example, a base station device, calibration is performed at the time that is allocated to the downlink communication. Consequently, calibration is not performed in the reception timing that is defined in TDD and thus the calibration signals are not emitted from the antennas in the reception timing.

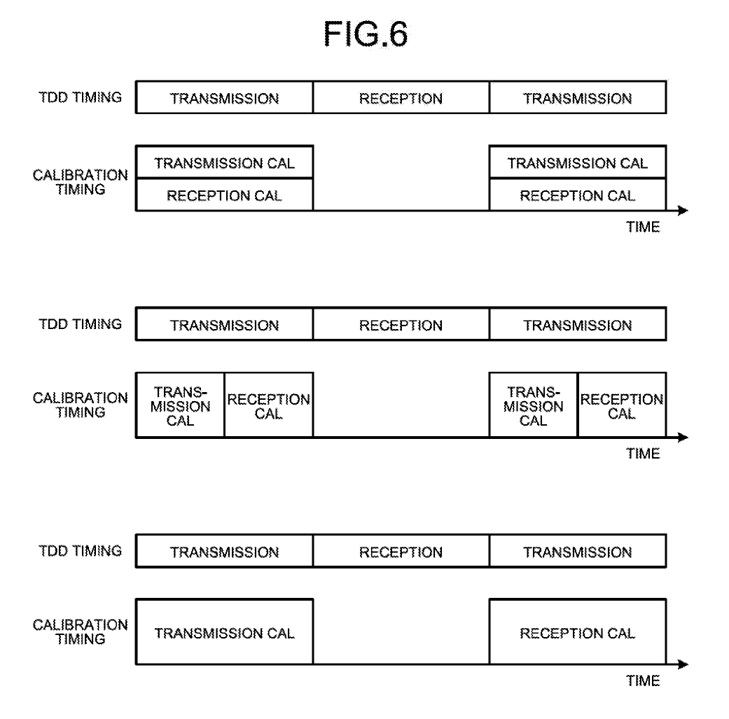

Furthermore, in the transmission timing defined in TDD, both the transmission calibration and the reception calibration may also simultaneously be performed or may also be performed in a time division manner. Specifically, for example, as illustrated in the upper portion of FIG. 6, in the transmission timing defined in TDD, the transmission calibration (represented by the “transmission CAL” in FIG.) and the reception calibration (represented by the “reception CAL” in FIG.) may also simultaneously be performed. Furthermore, as illustrated in the middle portion of FIG. 6, in a certain transmission timing in TDD, the transmission calibration and the reception calibration may also be performed in a time division manner. Furthermore, as illustrated in the lower portion of FIG. 6, transmission calibration and the reception calibration may also be performed in a time division manner across a plurality of transmission timings in TDD.

These calibration timing patterns may also appropriately be switched in accordance with, for example, the frequency of calibration to be performed, the processing load of each of the circuits, or the like, or the calibration may also always be performed in the calibration timing having the same pattern. Furthermore, in each of the patterns illustrated in FIG. 6, the calibration is performed in all of the transmission timings defined in TDD; however, there may also be a transmission timing in which calibration is not performed.

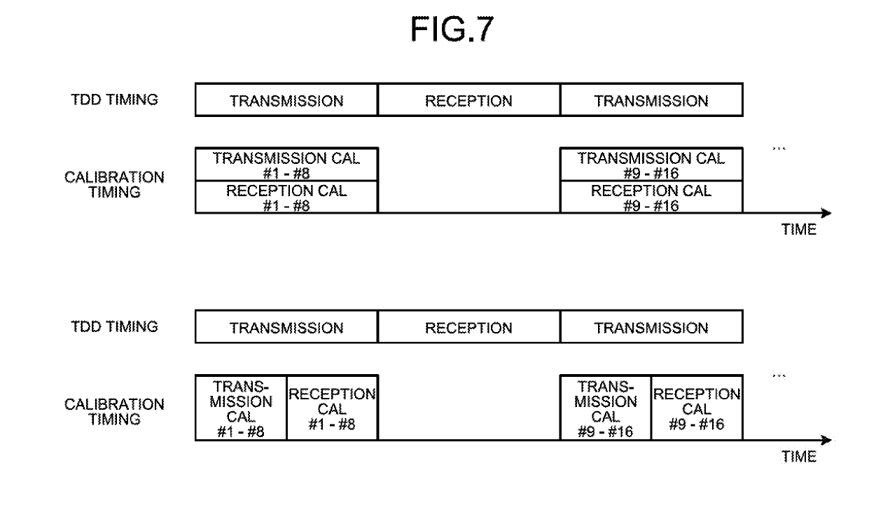

Furthermore, if the number of antennas is great, the antennas may also be grouped into a plurality of groups and calibration may also sequentially be performed on both the transmission circuits and the reception circuits associated with the antennas in the respective groups. Namely, for example, as illustrated in FIG. 7, in a certain transmission timing in TDD, calibration may also be performed on the 1^{st} to the 8^{th} transmission circuits and the 1^{st} to the 8^{th} reception circuits (represented by “transmission CAL #1 to #8” and “reception CAL #1 to #8” in FIG.), whereas, in the subsequent transmission timing, calibration may also be performed on the 9^{th} to the 16^{th} transmission circuits and the 9^{th} to the 16^{th} reception circuits (represented by “transmission CAL #9 to #16” and “reception CAL #9 to #16” in FIG.). At this time, as illustrated in the upper portion and the lower portion of FIG. 7, the transmission calibration and the reception calibration may also simultaneously be performed or may also be performed in a time division manner.

If the antennas are grouped into the plurality of groups, in a certain transmission timing in TDD, a calibration signal is output to some of the transmission circuits from among the plurality of the transmission circuits and, in the subsequent transmission timing, a calibration signal is output to the other some of the transmission circuits. Furthermore, in a certain transmission timing in TDD, a calibration signal is split into the DC that is provided on the antenna side of the one of the circulators from among the plurality of the circulators and, in the subsequent transmission timing, a calibration signal is split into the DC that is provided on the antenna side of the other one of the circulators. In this way, by limiting the number of transmission circuits and the DCs in which the calibration signals are simultaneously input, it is possible to reduce the level of the calibration signals emitted from the antennas.

As described above, according to the embodiment, in the transmission timing defined in TDD, different calibration signals are input to the plurality of the respective transmission circuits, the transmission characteristic of each of the transmission circuits is estimated from the calibration signals passing through the associated transmission circuits, and transmission calibration is performed. Furthermore, in the transmission timing defined in TDD, the calibration signals are input to the plurality of the reception circuits, the transmission characteristic of each of the reception circuits is estimated from the calibration signal passing through the associated reception circuit, and reception calibration is performed. Consequently, the calibration signals are not emitted from the antennas in the reception timing defined in TDD and it is possible to suppress the emission of unneeded radio waves. Furthermore, because switching of the switch is not needed at the time of calibration and calibration of the plurality of transmission circuits and the reception circuits can simultaneously be performed, it is possible to suppress an increase in the processing time and the size of the circuits.

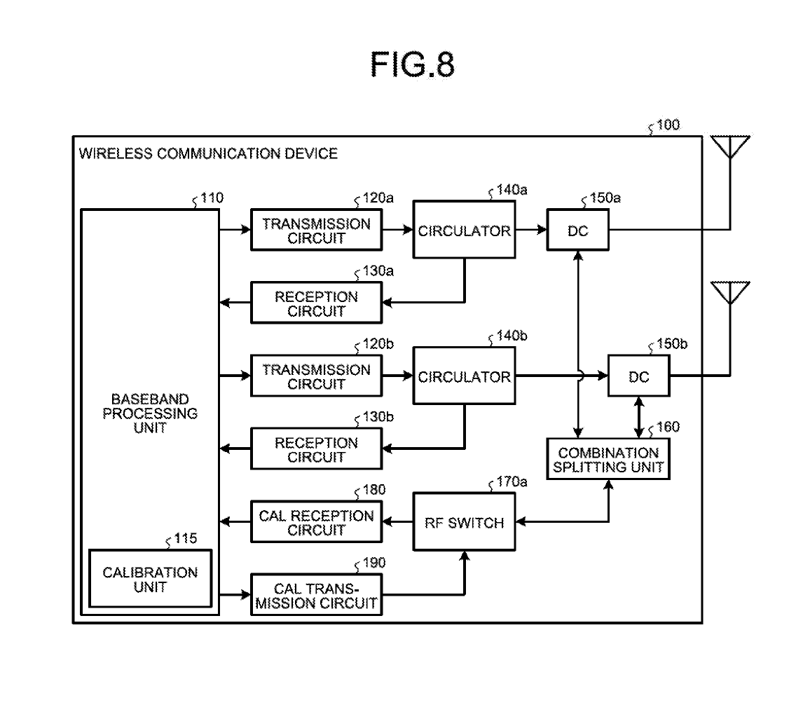

Furthermore, in the first embodiment, the combination splitting unit 160, the CAL reception circuit 180, and the CAL transmission circuit 190 are connected via the circulator 170; however, instead of the circulator 170, an RF switch may also be used. FIG. 8 is a block diagram illustrating a modification of the wireless communication device 100 according to the first embodiment. The wireless communication device 100 illustrated in FIG. 8 includes an RF switch 170a instead of the circulator 170 included in the wireless communication device 100 illustrated in FIG. 1.

The RF switch 170a outputs, to the CAL reception circuit 180, the signal that is output from the combination splitting unit 160. Namely, at the time of transmission calibration, the RF switch 170a connects the combination splitting unit 160 and the CAL reception circuit 180 and outputs, to the CAL reception circuit 180, the combined signal that is output from the combination splitting unit 160. Furthermore, the RF switch 170a outputs, to the combination splitting unit 160, the calibration signal that is output from the CAL transmission circuit 190. Namely, at the time of reception calibration, the RF switch 170a connects the CAL transmission circuit 190 and the combination splitting unit 160 and outputs, to the combination splitting unit 160, the calibration signal that is used for reception calibration.

In this way, when using the RF switch 170a, because the RF switch 170a is switched between the time of transmission calibration and the time of reception calibration, the transmission calibration and the reception calibration are performed in a time division manner. In other words, for example, at the timing illustrated in the middle portion or the lower portion of FIG. 6, the transmission calibration and the reception calibration are performed.

### [b] Second Embodiment

The characteristic of a second embodiment is that the transmission circuit and the reception circuit that are associated with one of the antennas are used as the transmission circuit and the reception circuit that are used for a calibration signal.

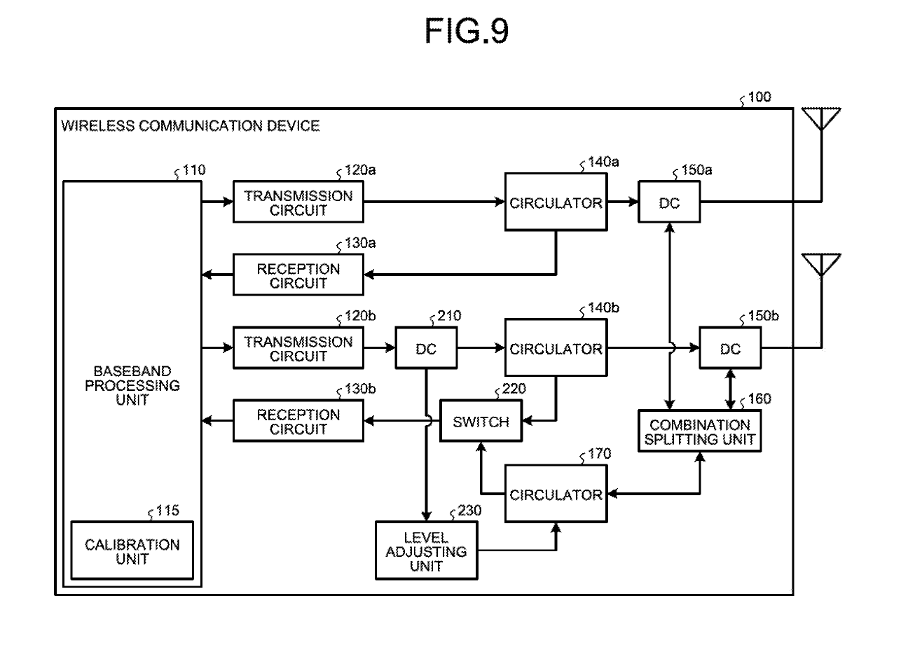

FIG. 9 is a block diagram illustrating the configuration of the wireless communication device 100 according to a second embodiment. In FIG. 9, the same parts as those illustrated in FIG. 1 are assigned the same reference numerals and descriptions thereof in detail will be omitted. The wireless communication device 100 illustrated in FIG. 9 has the configuration in which the CAL reception circuit 180 and the CAL transmission circuit 190 included in the wireless communication device 100 illustrated in FIG. 1 are deleted and a DC 210, a switch 220, and a level adjusting unit 230 are added.

The DC 210 outputs the transmission signal that is output from the transmission circuit 120b to the circulator 140b and also outputs the transmission signal to the level adjusting unit 230. Accordingly, in the transmission timing defined in TDD, the DC 210 outputs, to the level adjusting unit 230, the transmission signal to which the calibration signal is added. Namely, at the time of transmission calibration, the DC 210 outputs, to the level adjusting unit 230, the transmission signal to which the calibration signal used for transmission calibration is added. Furthermore, at the time of reception calibration, the DC 210 outputs, to the level adjusting unit 230, the transmission signal to which calibration signal used for reception calibration is added.

The switch 220 connects, in the reception timing defined in TDD, the circulator 140b and the reception circuit 130b. In contrast, the switch 220 connects, in the transmission timing defined in TDD, one of the circulator 140b and the circulator 170 to the reception circuit 130b in accordance with the transmission calibration time or the reception calibration time. Specifically, the switch 220 connects, at the time of transmission calibration, the circulator 170 and the reception circuit 130b and allows the combined signal of the transmission signals that have passed through the respective transmission circuits 120a and 120b to be input to the reception circuit 130b. Furthermore, the switch 220 connects, at the time of reception calibration, the circulator 140b and the reception circuit 130b and allows the calibration signal that is split into the antennas to be input to the reception circuit 130b.

The level adjusting unit 230 attenuates, at the time of transmission calibration, the level of the transmission signal output from the DC 210 and prevents the transmission signal to which the calibration signal is added from leaking from the circulator 170 to the combination splitting unit 160 or the reception circuit 130b. Furthermore, the level adjusting unit 230 adjusts, at the time of reception calibration, the level of the transmission signal output from the DC 210 and allows the level of the transmission signal to which the calibration signal is added to be within the dynamic range of the reception circuits 130a and 130b.

In the embodiment, the transmission circuit 120b and the reception circuit 130b also act as the transmission circuit and the reception circuit for the calibration signal. Accordingly, the calibration unit 115 acquires, from the reception circuit 130b at the time of transmission calibration, the combined signal of the calibration signals and the transmission signals that have passed through the transmission circuits 120a and 120b. Furthermore, at the reception calibration, the calibration unit 115 adds the generated calibration signal to the transmission signal and then outputs the transmission signal to the transmission circuit 120b.

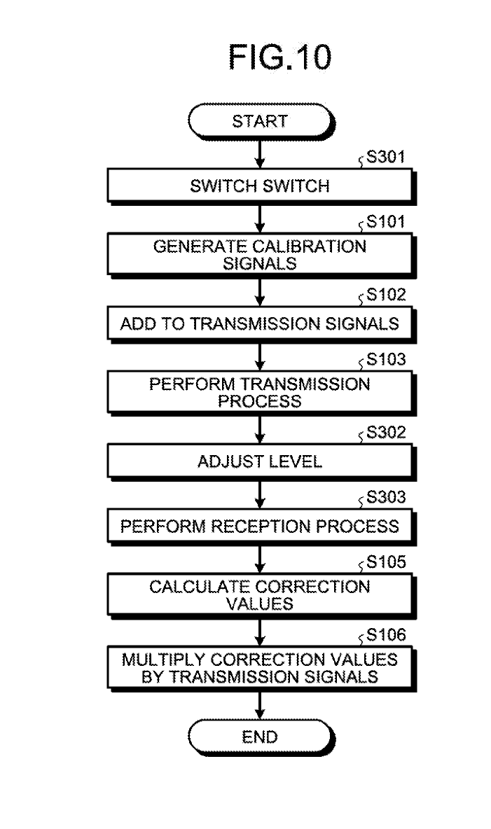

In the following, the transmission calibration performed in the wireless communication device 100 configured described above will be described with reference to the flowchart illustrated in FIG. 10. In FIG. 10, the same processes as those illustrated in FIG. 2 are assigned the same reference numerals and descriptions thereof in detail will be omitted.

At the transmission calibration, the switch 220 is switched such that the circulator 170 and the reception circuit 130b are connected (Step S301). By switching the switch 220 in this way, the combined signal of the calibration signals and the transmission signals passed through the respective transmission circuits 120a and 120b is input from the circulator 170 to the reception circuit 130b.

Then, the calibration signals that are different in accordance with the transmission circuits 120a and 120b are generated by the calibration unit 115 (Step S101). The generated calibration signals are added to the respective transmission signals (Step S102) and are output to the transmission circuits 120a and 120b. In the transmission circuits 120a and 120b, the transmission process with respect to the transmission signals to each of which the calibration signal is added is performed (Step S103).

The transmission signals that have been subjected to the transmission process are transmitted via the respective antennas by way of the circulators 140a and 140b and the DCs 150a and 150b, respectively. Furthermore, in the DCs 150a and 150b, the transmission signals to each of which the calibration signal is added are also output to the combination splitting unit 160. The transmission signals that are output from the DCs 150a and 150b are combined by the combination splitting unit 160 and the obtained combined signal is input to the reception circuit 130b by way of the circulator 170 and the switch 220.

Here, the transmission signal that has been subjected to the transmission process by the transmission circuit 120b is also output to the level adjusting unit 230 by the DC 210. At the time of transmission calibration, because the calibration signal that is added to the transmission signal that is output from the DC 210 to the circulator 140b is used, the calibration signal that is added to the transmission signal transmitted from the DC 210 to the level adjusting unit 230 is not needed. Thus, the level of the transmission signal that is output from the DC 210 is attenuated by the level adjusting unit 230 (Step S302) and the level of the signal that is output to the circulator 170 is reduced. Consequently, it is possible to reduce the signal level leaking from the circulator 170 to the combination splitting unit 160 or the reception circuit 130b and it is possible to suppress the emission of unneeded radio waves or a decrease in the accuracy of calibration.

If the combined signal is input to the reception circuit 130b, the reception process with respect to the combined signal is performed (Step S303). Specifically, the combined signal is subjected to down conversion and AD conversion by the reception circuit 130b and the combined signal having the baseband frequency is output to the calibration unit 115. At this time, in the combined signal that is to be subjected to the reception process by the reception circuit 130b, the transmission signals that have been subjected to the transmission process by the transmission circuits 120a and 120b and the calibration signals that are added to the respective transmission signals are included.

If the combined signal including the calibration signal is input to the calibration unit 115, the calibration signal for each transmission circuit is extracted by the calibration unit 115. Then, by comparing the phase and the amplitude of the extracted calibration signals with the phase and the amplitude of the calibration signals that are generated at first, the transmission characteristics of the transmission circuits 120a and 120b are estimated and the correction values are calculated from the transmission characteristics for each of the transmission circuits (Step S105).

After the correction values for each of the transmission circuits are calculated by the calibration unit 115, the correction value is multiplied by each of the transmission signals that are output to the associated transmission circuits (Step S106). Consequently, it is possible to assume that the transmission signals to be subjected to the transmission process by the respective transmission circuits 120a and 120b are transmitted to the antennas with the same transmission characteristic as that of the one of the transmission circuits and the transmission characteristics of the transmission circuits associated with the respective antennas can be made to match.

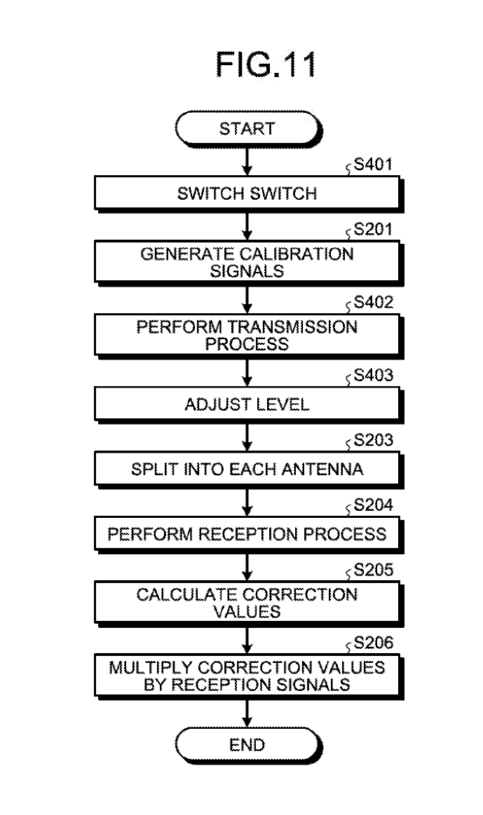

In the following, the reception calibration performed in the wireless communication device 100 according to the second embodiment will be described with reference to the flowchart illustrated in FIG. 11. In FIG. 11, the same processes as those illustrated in FIG. 4 are assigned the same reference numerals and descriptions thereof in detail will be omitted.

At the time of reception calibration, the switch 220 is switched such that the circulator 140b and the reception circuit 130b are connected (Step S401). By switching the switch 220 in this way, the calibration signal that is split into the DC 150b by the combination splitting unit 160 is input from the circulator 140b to the reception circuit 130b.

Then, the calibration signal that is common to the reception circuits 130a and 130b is generated by the calibration unit 115 (Step S201). The generated calibration signal is input to the transmission circuit 120b and then the transmission process with respect to the calibration signal is performed by the transmission circuit 120b (Step S402). Specifically, the DA conversion and up conversion is performed on the calibration signal by the transmission circuit 120b and the calibration signal having the radio frequency is output to the level adjusting unit 230 by way of the DC 210. At this time, the calibration signal may also be added to the transmission signal.

The calibration signal that is output to the level adjusting unit 230 is subjected to level adjustment by the level adjusting unit 230 so as to have the appropriate level (Step S403). Namely, for example, if the calibration signal is added to the transmission signal, due to transmission electrical power control, the level of the transmission signal including the calibration signal is amplified to the relatively high level. Consequently, if this transmission signal is input to the reception circuits 130a and 130b without processing anything, the reception circuits 130a and 130b may possibly be damaged. Thus, the level of the transmission signal is adjusted by the level adjusting unit 230 to the level within the dynamic range of the reception circuits 130a and 130b.

The calibration signal that has been subjected to the level adjustment is output to the combination splitting unit 160 by way of the circulator 170 and is split, by the combination splitting unit 160, into the DCs 150a and 150b associated with the respective antennas (Step S203). The calibration signal split into the DCs 150a and 150b is input to the reception circuits 130a and 130b by way of the circulators 140a and 140b, respectively.

If the calibration signal is input to the reception circuits 130a and 130b, the reception process with respect to the calibration signal is performed (Step S204). If the calibration signal for each reception circuit is input to the calibration unit 115, by comparing the phase and the amplitude of the calibration signal of each of the reception circuits with the phase and the amplitude of the calibration signal that is generated at first, the transmission characteristics of the reception circuits 130a and 130b are estimated. Then, the correction values that are used to match the transmission characteristics of the reception circuits are calculated from the transmission characteristics for each of the reception circuits (Step S205).

After the correction values for each of the reception circuits are calculated by the calibration unit 115, the correction value is multiplied by the reception signal that is output from each of the associated reception circuits (Step S206). Consequently, it is possible to assume that the reception signals to be subjected to the reception process by the respective reception circuits 130a and 130b are transmitted from the antenna with the same transmission characteristics as that of one of the reception circuits and thus it is possible to match the transmission characteristics of the reception circuits associated with the respective antennas.

As described above, according to the embodiment, because the transmission circuit and the reception circuit that are associated with a single antenna are also used as the transmission circuit and the reception circuit that are used for the calibration signals, it is possible to suppress an increase in the size of circuits used for calibration.

### [c] Third Embodiment

The characteristic of a third embodiment is that a decrease in the accuracy of calibration is suppressed by cancelling the signal leaking from the circulator to the reception circuit.

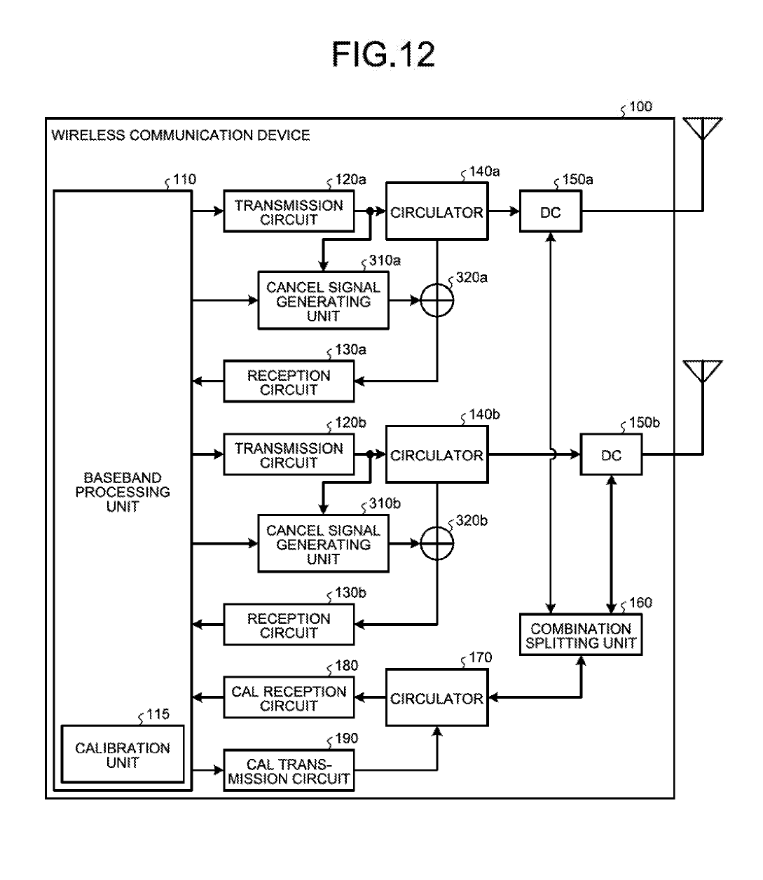

FIG. 12 is a block diagram illustrating the configuration of the wireless communication device 100 according to a third embodiment. In FIG. 12, the same parts as those illustrated in FIG. 1 are assigned the same reference numerals and descriptions thereof in detail will be omitted. The wireless communication device 100 illustrated in FIG. 12 has the configuration in which cancel signal generating units 310a and 310b and adders 320a and 320b are added to the wireless communication device 100 illustrated in FIG. 1.

The cancel signal generating units 310a and 310b generate cancel signals that cancel the transmission signals at the time of reception calibration in accordance with an instruction from the baseband processing unit 110. Namely, the cancel signal generating units 310a and 310b generate the cancel signals having the opposite phase of the transmission signals that have been subjected to the transmission process by the transmission circuits 120a and 120b. This cancel signal is a cancel signal that is used to cancel the signal component leaking into the reception circuits 130a and 130b due to a lack of isolation of the circulators 140a and 140b or reflection from the edge of the antennas.

Furthermore, if the transmission signals wrap around between different antennas, the cancel signal generating units 310a and 310b generate cancel signals by also using the transmission signal that has been subjected to the transmission process by the transmission circuit that is associated with the other antenna. Namely, for example, if a wraparound of the transmission signals between the antennas associated with the transmission circuits 120a and 120b occurs, the cancel signal generating unit 310a generates a cancel signal by using the transmission signals that have been subjected to the transmission process by the two transmission circuits 120a and 120b. Similarly, the cancel signal generating unit 310b generates a cancel signal by using the transmission signals that have been subjected to the transmission process by the two transmission circuits 120a and 120b.

The adders 320a and 320b add the cancel signals generated by the respective cancel signal generating units 310a and 310b to the calibration signals that are output from the respective circulators 140a and 140b, respectively. Namely, the adders 320a and 320b add the cancel signals to the calibration signals that are output from the respective circulators 140a and 140b at the time of reception calibration and remove the transmission signal components leaking into the circulators 140a and 140b, respectively.

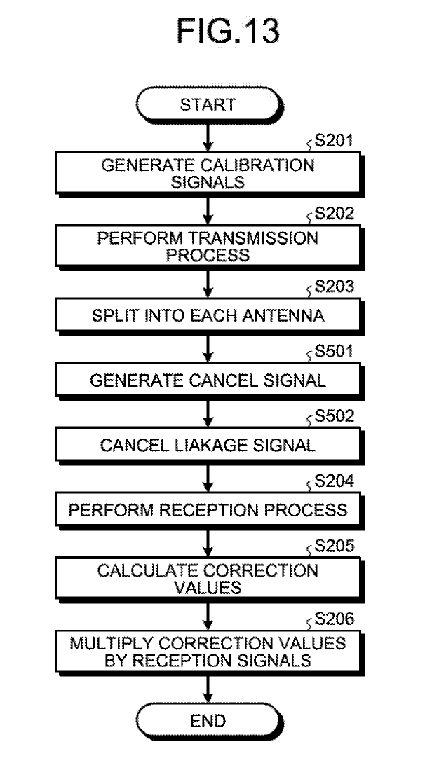

In the following, the reception calibration performed in the wireless communication device 100 configured described above will be described with reference to the flowchart illustrated in FIG. 13. In FIG. 13, the same parts as those illustrated in FIG. 4 are assigned the same reference numerals and descriptions thereof in detail will be omitted. Furthermore, the transmission calibration according to the third embodiment is the same as that described in the first embodiment.

At the time of reception calibration, a calibration signal that is common to the reception circuits 130a and 130b is generated by the calibration unit 115 (Step S201). The generated calibration signal is input to the CAL transmission circuit 190 and the transmission process with respect to the calibration signal is performed by the CAL transmission circuit 190 (Step S202).

The calibration signal that has been subjected to the transmission process is output from the circulator 170 to the combination splitting unit 160 and is split, by the combination splitting unit 160, into the DCs 150a and 150b that are associated with the respective antennas (Step S203).

Incidentally, because the reception calibration is performed by the transmission timing defined in TDD, the transmission process with respect to the transmission signals is performed by the transmission circuits 120a and 120b. The transmission signals that have been subjected to the transmission process are transmitted from the antenna; however, at this time, due to a lack of isolation of the circulators 140a and 140b, reflection at the edge of the antennas, or the like, a part of the transmission signals leaks into the reception circuits 130a and 130b. Thus, by using the transmission signals, the cancel signals that cancel the leaking signals leaking into the reception circuits 130a and 130b are generated by the cancel signal generating units 310a and 310b (Step S501).

At this time, if transmission signals are wrapped around between different antennas, the transmission signals wrapped around between the antennas also leak into the reception circuits 130a and 130b. Consequently, by also simultaneously using transmission signals that have been subjected to the transmission process by the transmission circuits that are associated with the other antennas, the cancel signals may also be generated by the cancel signal generating units 310a and 310b.

Then, if the calibration signals that have been split into the DCs 150a and 150b are output from the circulators 140a and 140b, the leaking signals that are output together with the calibration signals are canceled by the adders 320a and 320b, respectively (Step S502). Namely, by adding the cancel signals to the signals that are output from the circulators 140a and 140b, the leakage transmission signal components due to a lack of isolation of the circulators 140a and 140b or reflection at the edge of the antennas are removed. After the leakage signals have been cancelled, the calibration signals are input to the reception circuits 130a and 130b.

In this way, because the cancel signals are added to the signals that are output from the circulators 140a and 140b, interference with the calibration signals due to the leakage signals is decreased. Consequently, it is possible to suppress a decrease in the accuracy of reception calibration. Furthermore, it is assumed that the leakage signals are the signals having relatively high electrical power generated based on the transmission signals; however, because the leakage signals are canceled by the cancel signals, the signals having high electrical power are not input to the reception circuits 130a and 130b. In other words, the leakage signals having high electrical power can prevent the reception circuits 130a and 130b from being damaged and can protect the reception circuits 130a and 130b.

If the calibration signals are input to the reception circuits 130a and 130b, the reception process with respect to the calibration signals is performed (Step S204). If the calibration signal for each reception circuit is input to the calibration unit 115, by comparing the phase and the amplitude of the calibration signal of each of the reception circuits with the phase and the amplitude of the calibration signal generated at first, the transmission characteristics of the reception circuits 130a and 130b are estimated. Then, the correction values that are used to match the transmission characteristics of the reception circuits are calculated from the transmission characteristics of the respective reception circuits (Step S205).

After the correction value for each reception circuit has been calculated by the calibration unit 115, the correction value is multiplied by the reception signal that is output from each of the reception circuits (Step S206). Consequently, it is possible to assume that the reception signal that is subjected to the reception process by each of the reception circuits 130a and 130b is transmitted from the antenna with the same transmission characteristic as that of one of the reception circuits and thus it is possible to match the transmission characteristics of the reception circuits associated with the respective antennas.

As described above, according to the embodiment, a cancel signal that cancels the signal leaking from the circulator to the reception circuit side is generated and, at the time of reception calibration, the cancel signal is added to the signal that is output from the circulator to the reception circuit. Consequently, it is possible to cancel the transmission signal component leaking into the reception circuit side due to a lack of isolation of the circulator or reflection at the edge of the antenna and it is possible to suppress interference with the calibration signals. Furthermore, it is possible to prevent a leakage signal having relatively high electrical power from being input to the reception circuit and thus it is possible to protect the reception circuit.

### [d] Fourth Embodiment

The characteristic of a fourth embodiment is that, if the level of the signal output from the circulator to the reception circuit is equal to or greater than a predetermined value, the level of this signal is limited and, during the time period for which the level is limited, reception calibration is suspended.

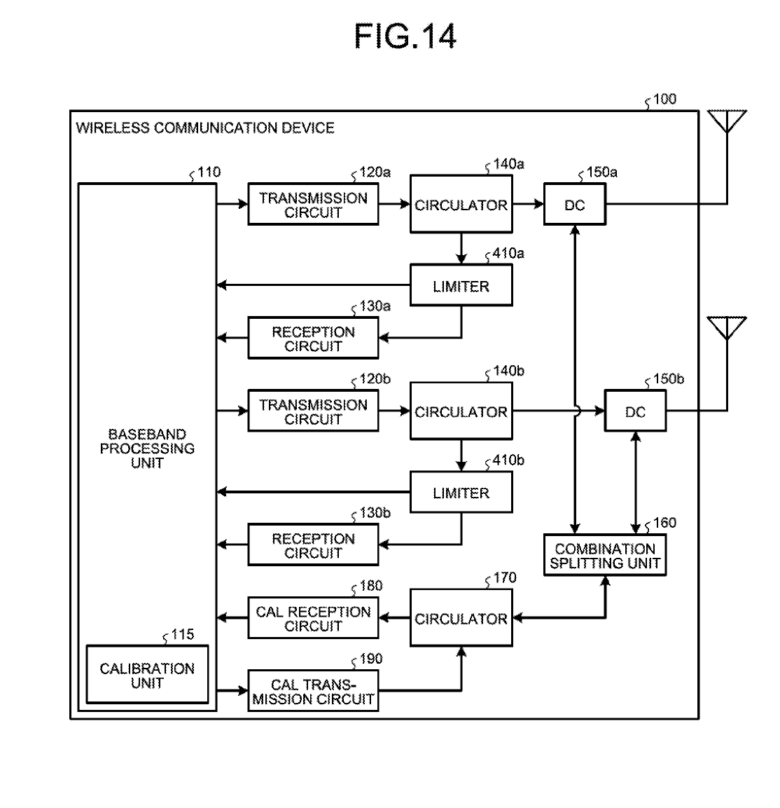

FIG. 14 is a block diagram illustrating the configuration of the wireless communication device 100 according to a fourth embodiment. In FIG. 14, the same parts as those illustrated in FIG. 1 are assigned the same reference numerals and descriptions thereof in detail will be omitted. The wireless communication device 100 illustrated in FIG. 14 has the configuration in which limiters 410a and 410b are added to the wireless communication device 100 illustrated in FIG. 1.

The limiters 410a and 410b limit the level of the signals that are output from the circulators 140a and 140b to a predetermined value and output the signals with the level less than the predetermined value to the reception circuits 130a and 130b, respectively. Namely, if the level of the signals that are output from the circulators 140a and 140b is equal to or greater than the predetermined value, the limiters 410a and 410b suppress the level of the signal and output the signal with the suppressed level to the reception circuits 130a and 130b, respectively. Then, when the limiters 410a and 410b suppress the level of the signal, the limiters 410a and 410b notify the calibration unit 115 in the baseband processing unit 110 of that effect.

In the embodiment, the level of the signals output from the circulators 140a and 140b is limited by the limiters 410a and 410b. Consequently, for example, if the transmission signal component with relatively high electrical power leaks into the reception circuits 130a and 130b side due to a lack of isolation of the circulators 140a and 140b or reflection at the edge of the antenna, the level of the signals that are input to the reception circuits 130a and 130b can be decreased. Consequently, it is possible to prevent damage of the reception circuits 130a and 130b and protect the reception circuits 130a and 130b.

Furthermore, because the level of the signals is suppressed during the time period in which the limiters 410a and 410b are being operated, the waveform of the calibration signal is distorted, it is difficult to perform accurate reception calibration. Consequently, when the limiters 410a and 410b suppress the level of the signals, this status is sent to the calibration unit 115 as a notification, the calibration unit 115 suspends the reception calibration during the time period in which notification is being received.

As described above, according to the embodiment, because the level of the signals output from the circulators is limited by the limiters, it is possible to prevent the leakage signals, which have relatively high electrical power due to a lack of isolation of the circulator or reflection at the edge of the antennas, from being input to the reception circuits and it is possible to protect the reception circuits.

Furthermore, in the fourth embodiment, it is possible to protect the reception circuits 130a and 130b by using, instead of the limiters 410a and 410b, an RF switch. Specifically, for example, the baseband processing unit 110 monitors the level of the signals that are output from the circulators 140a and 140b. Then, if the level of the signals is equal to or greater than a predetermined value, the baseband processing unit 110 may also disconnect the RF switch that is disposed between the circulators 140a and 140b and the reception circuits 130a and 130b.

Furthermore, the embodiments described above can be appropriately used in combination. For example, if the second embodiment and the third embodiment are combined and if the transmission circuit and the reception circuit associated with one of the antennas are used as the transmission circuit and the reception circuit that are used for the calibration signal, it may also possible to add the cancel signal to the signal that is output form the circulator. Furthermore, the third embodiment and the fourth embodiment may also be combined, the cancel signal may also be added to the signal that is output from the circulator, and then the level of the signal obtained after the cancel signal has been added may also be limited by the limiter.

According to an aspect of an embodiment of the wireless communication device and the calibration method disclosed in the present invention, an advantage is provided in that an increase in processing time and the size of circuits can be suppressed while suppressing the emission of radio waves unneeded at the time of calibration.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device comprising:
a plurality of antennas;
a plurality of transmission circuits that perform a transmission process on signals transmitted from the plurality of the respective antennas;
a plurality of reception circuits that perform a reception process on signals received by the plurality of the respective antennas;
a plurality of connecting units that connect the transmission circuits and the reception circuits associated with the plurality of the respective antennas, that output, to the respective antennas, the signals input from transmission circuit side, and that output, to the respective reception circuits, the signals input from antenna side; and
a processor that is connected to the plurality of the transmission circuits and the plurality of the reception circuits, wherein the processor executes a process comprising:
outputting, at a timing allowed for signal transmission from the plurality of the antennas, first calibration signals that are different for the plurality of the transmission circuits;
calculating, by using the first calibration signals having passed through the plurality of the transmission circuits and the respective connecting units, a first correction value that corrects a difference between the transmission characteristics of the plurality of the transmission circuits;
outputting, at the timing allowed for the signal transmission from the plurality of the antennas, a second calibration signal that is common to the plurality of the reception circuits; and
calculating, by using the second calibration signal having passed through the plurality of the connecting units and the respective reception circuits, a second correction value that corrects a difference between the transmission characteristics of the plurality of the reception circuits.

2. The wireless communication device according to claim 1, wherein
the outputting the second calibration signal includes outputting the second calibration signal to a calibration transmission circuit that performs the transmission process on the second calibration signal, and wherein
the wireless communication device further comprises a splitter that splits the second calibration signal output from the calibration transmission circuit into directional couplers provided on the antenna side of the plurality of the respective connecting units.

3. The wireless communication device according to claim 1, wherein
the outputting the second calibration signal includes outputting the second calibration signal to a first transmission circuit from among the plurality of the transmission circuits, and wherein
the wireless communication device further comprises a splitter that splits the second calibration signal output from the first transmission circuit into the directional couplers provided on the antenna side of the plurality of the respective connecting units.

4. The wireless communication device according to claim 1, wherein
the calculating the first correction value includes acquiring a combined signal obtained by combining the first calibration signals having passed through the plurality of the transmission circuits and the respective connecting units, from a calibration reception circuit that performs the reception process on the combined signal, and
extracting, from the acquired combined signal, the first calibration signals having passed through the respective transmission circuits.

5. The wireless communication device according to claim 1, wherein
the calculating the first correction value includes acquiring, from a first reception circuit from among the plurality of the reception circuits, a combined signal obtained by combining the first calibration signals having passed through the plurality of the transmission circuits and the respective connecting units, and
extracting, from the acquired combined signal, the first calibration signals having passed through the respective transmission circuits.

6. The wireless communication device according to claim 1, further comprising:
a generator that generates, based on the transmission signal output from the transmission circuit, a cancel signal that cancels a transmission signal component leaking into reception circuit side of the connecting unit; and
an adder that adds the cancel signal generated by the generator to the signal output from the connecting unit to the reception circuit.

7. The wireless communication device according to claim 1, further comprising a limiter that limits level of the signal output from the connecting unit to the reception circuit.

8. The wireless communication device according to claim 1, wherein
the outputting the first calibration signals includes outputting, at a first timing allowed for signal transmission from the plurality of the antennas, the first calibration signals to some of the transmission circuits from among the plurality of the transmission circuits, and
outputting, at a second timing allowed for signal transmission from the plurality of the antennas, the first calibration signals to some other of the transmission circuits from among the plurality of the transmission circuits.

9. The wireless communication device according to claim 1, further comprising a splitter that splits, at a first timing allowed for the signal transmission from the plurality of the antennas, the second calibration signal into directional couplers provided on the antenna side of some of the respective connecting units from among the plurality of the connecting units, and that splits, at a second timing allowed for the signal transmission from the plurality of the antennas, the second calibration signal into directional couplers provided on the antenna side of some other of the respective connecting units from among the plurality of the connecting units.

10. A calibration method performed by a wireless communication device that includes a plurality of antennas, a plurality of transmission circuits that perform a transmission process on signals transmitted from the plurality of the respective antennas, a plurality of reception circuits that perform a reception process on signals received by the plurality of the respective antennas, and a plurality of connecting units that connect the transmission circuits and the reception circuits associated with the plurality of the respective antennas, that output the signals input from transmission circuit side to the respective antennas, and that output the signals input from antenna side to the respective reception circuits, the calibration method comprising:
outputting, at a timing allowed for signal transmission from the plurality of the antennas, first calibration signals that are different for the plurality of the transmission circuits;
calculating, by using the first calibration signals having passed through the plurality of the transmission circuits and the respective connecting units, a first correction value that corrects a difference between the transmission characteristics of the plurality of the transmission circuits;
outputting, at the timing allowed for the signal transmission from the plurality of the antennas, a second calibration signal that is common to the plurality of the reception circuits; and
calculating, by using the second calibration signal having passed through the plurality of the connecting units and the respective reception circuits, a second correction value that corrects a difference between the transmission characteristics of the plurality of the reception circuits.
